(19) United States
(12) Patent Application Publication
(10) Pub. No.: US 2016/0021205 A1
(43) Pub. Date: Jan. 21, 2016

(54) AUTOMATIC DETECTION OF VIP GUESTS ON WIRELESS NETWORKS

(71) Applicant: Aruba Networks, Inc., Sunnyvale, CA (US)

(72) Inventor: Carl Mower, Sunnyvale, CA (US)

(73) Assignee: ARUBA NETWORKS, INC., Sunnyvale, CA (US)

(21) Appl. No.: 14/332,009

(22) Filed: Jul. 15, 2014

(51) Int. Cl. H04L 29/08; H04L 12/26

(52) U.S. Cl. CPC H04L 67/24; H04L 43/10; H04L 67/306

(57) ABSTRACT

The present disclosure discloses a method and network device for automatic detection of VIP guests on wireless networks. The network device can receive a request for network access, by a client device used by a guest user, at a location associated with an entity. Furthermore, the network device can identify characteristics of a sponsor of the guest user, the sponsor being associated with the entity; and/or email domain for the guest user; and/or characteristics of a particular check-in station at which the guest user checked in for access at the location associated with the entity. The network device then determines a set of one or more characteristics of the network access by the client device used by the guest user, and provides the client device used by the guest user network access per the determined set of characteristics of the network access.

### FIELD

Embodiments of the present disclosure relate to client management in local area networks. In particular, embodiments of the present disclosure describe a method and network device for automatic detection of VIP guests on wireless networks.

### BACKGROUND

Guest users on wireless networks may desire to have various levels of guest statuses. For example, some guest users may be an organization's VIP guests, whereas other guest users are non-VIP guests. It is possible for an organization to create more than two tiers of guest statuses. The VIP guests should be granted preferred access to wireless networks compared to the non-VIP guests.

In some cases, the guest status may be inferred from an attribute of a visiting person. For example, a government official may be always granted a VIP guest status. In some cases, the guest status may be inferred from a corporate sponsor for the visiting person (e.g., who the guest user visits in the organization). For example, a business partner who visits the CEO of the organization will be granted a VIP guest status.

Currently, determining which level of guest status to be granted to a particular visitor to an organization is a manual process that requires a human being with specialized knowledge of the organization's human resource structures to perform. This is error prone and inefficient.

### BRIEF DESCRIPTION OF THE DRAWINGS

The present disclosure may be best understood by referring to the following description and accompanying drawings that are used to illustrate embodiments of the present disclosure.

FIG. 1 shows an exemplary network diagram illustrating an exemplary automatic detection of VIP guests based on attributes of the sponsor according to embodiments of the present disclosure.

FIG. 2 shows an exemplary network diagram illustrating an exemplary automatic detection of VIP guests based on a determination by the sponsor according to embodiments of the present disclosure.

FIG. 3 shows an exemplary network diagram illustrating an exemplary automatic detection of VIP guests based on the source of guest registration according to embodiments of the present disclosure.

FIG. 4 shows an exemplary network diagram illustrating an exemplary automatic detection of VIP guests based on email domain of the visitor according to embodiments of the present disclosure.

FIG. 5 illustrates an exemplary process for automatic detection of VIP guests on wireless networks according to embodiments of the present disclosure.

FIG. 6 illustrates an exemplary process for automatic detection of VIP guests on wireless networks according to embodiments of the present disclosure.

FIG. 7 illustrates an exemplary process for automatic detection of VIP guests on wireless networks according to embodiments of the present disclosure.

FIG. 8 is a block diagram illustrating an exemplary system for automatic detection of VIP guests on wireless networks according to embodiments of the present disclosure.

### DETAILED DESCRIPTION

In the following description, several specific details are presented to provide a thorough understanding. While the context of the disclosure is directed to client management in local area networks, one skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein. It should be understood that this disclosure covers all modifications, equivalents, and alternatives falling within the spirit and scope of the present disclosure.

### Overview

Embodiments of the present disclosure relate to client management in local area networks. In particular, embodiments of the present disclosure describe a method and network device for automatic detection of VIP guests on wireless networks. With the solution provided herein, the network device can receive a request for network access, by a client device used by a guest user, at a location associated with an entity. Furthermore, the network device can identify characteristics of a sponsor of the guest user, the sponsor being associated with the entity; and/or email domain for the guest user; and/or characteristics of a particular check-in station at which the guest user checked in for access at the location associated with the entity. The network device then determines a set of one or more characteristics of the network access by the client device used by the guest user, and provides the client device used by the guest user network access per the determined set of characteristics of the network access.

### Automatic Detection Based on Attributes of Sponsor

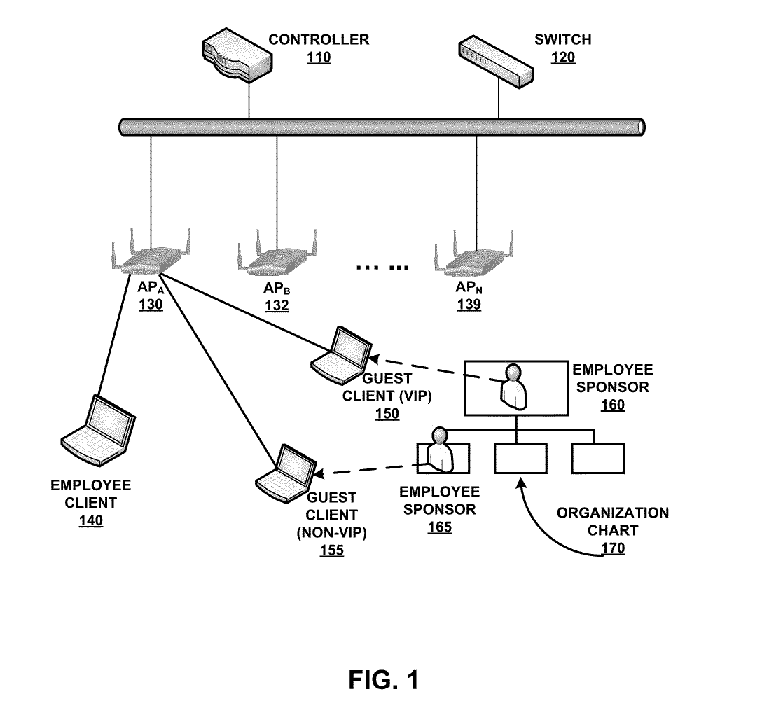

FIG. 1 shows an exemplary network diagram illustrating an exemplary automatic detection of VIP guests based on attributes of the sponsor according to embodiments of the present disclosure. Specifically, FIG. 1 illustrates a network that includes at least a switch 120, a network controller 110, and a plurality of network devices, such as AP_{A} 130, AP_{B} 132, . . . , AP_{N} 139. Furthermore, multiple client devices are associated with each access point. Some client devices are registered employee devices, such as, employee client 140. Other client devices are guest devices, such as guest client 150 and guest client 155.

Network controller 110 generally refers to a controlling device that manages other network devices such as wireless access points. Network controller 110 may handle automatic adjustments to radio frequency power, wireless channels, wireless authentication, and/or security. Furthermore, network controller 110 can be combined to form a wireless mobility group to allow inter-controller roaming. Network controller 110 can be part of a mobility domain to allow clients access throughout large or regional enterprise facility locations. This saves the clients time and administrators overhead because it can automatically re-associate or re-authenticate.

Switch 120 generally refers to a computer networking device that is used to connect devices together on a computer network by performing a form of packet switching. A switch can send a message only to the port connected to the device that needs or requests the message. A switch is a multi-port network bridge that processes and forwards data at the data link layer (layer-2) of the OSI (Open Systems Interconnection) model. A switch may also have additional features, including the ability to route packets, e.g., as layer-3 or multilayer switches.

Access points, such as AP_{A} 110, AP_{B} 112, . . . , AP_{N} 119, generally refer to a wireless network device that allows wireless client devices to connect to a wired network using IEEE 802.11 or related standards. The APs usually connect to a router or a switch via a wired network, but can also be an integral component of the router itself.

During operation, a mobile client device, such as guest client device 150, may request for network access. The network device may determine an employee sponsor (e.g., employee sponsor 160) for the guest client device (e.g., guest client 150). In some embodiments, the network device may look up a pre-configured static list of employees including specifically named individuals. If a guest user is registered to visit an employee sponsor that belongs to the pre-configured list of employees, the mobile client device of the guest user will be granted a high level guest status, e.g., a VIP guest status.

In some embodiments, the network device may determine an internal grade level associated with the employee sponsor, for example, a CEO, a VP, a managerial employee, a non-managerial employee, etc. The network device may inquire a human resource database, e.g., an Active Directory® database, a Workday® database, a SuccessFactors® database, a PeopleSoft® database, etc. If the internal grade level associated with the employee sponsor is greater than a preconfigured value, the mobile client device of the guest user will be granted a high level guest status, e.g., a VIP guest status.

In some embodiments, the network may determine a status associated with the employee sponsor, for example, as a full-time employee, a part-time employee, a contract employee, an employee currently on leave, etc.

### Automatic Detection Based on Determination by Sponsor

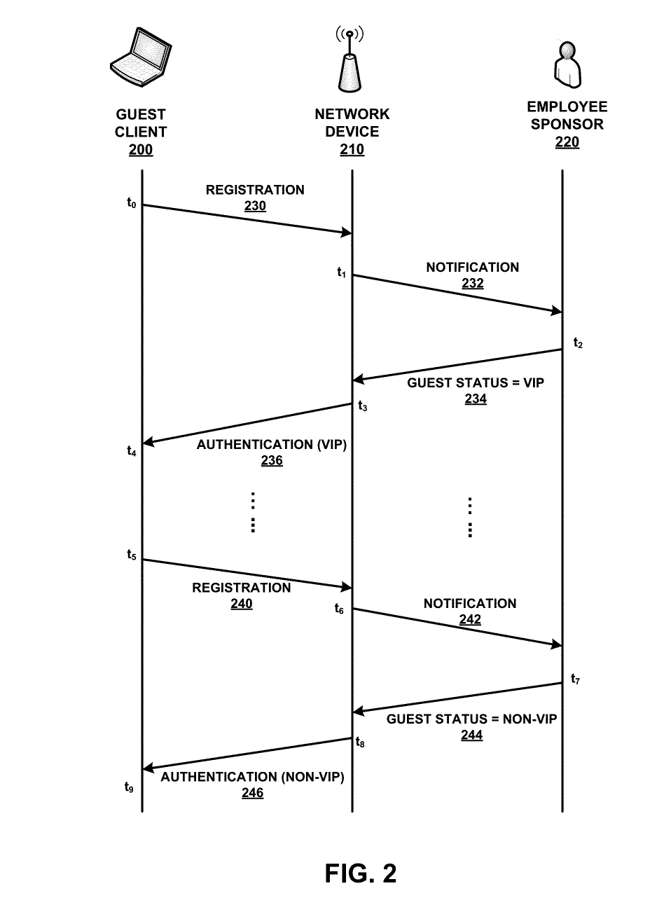

FIG. 2 shows an exemplary network diagram illustrating an exemplary automatic detection of VIP guests based on a determination by the sponsor according to embodiments of the present disclosure. Specifically, FIG. 2 illustrates a network that includes at least a guest client device 200, a network device 210, and an employee sponsor 220.

As illustrated in FIG. 2, at time point tₒ, a guest user using guest client device 200 arrives at a facility of an organization and completes registration 230. During registration process, the guest user is prompted to provide the identity of his or her employee sponsor, along with other information such as the guest user's identity, contact information, reason for visit, etc. In some embodiments, the employee sponsor can be the person whom the guest user comes to visit. In some embodiments, the employee sponsor can be an organizer of a meeting that the guest user comes to attend. In some embodiments, the employee sponsor can be a person who invites the guest user to the facility.

Upon receiving the guest registration information by the network infrastructure, at time point t₁, a network device 210 sends a notification message 232 to employee sponsor 220. Notification message 232 can be, but is not limited to, a text message, a voicemail, a phone call, an email, a pop-up message from a mobile application, etc. Notification message 232 informs employee sponsor 220 that the guest user associated with client device 200 has arrived at the facility and requests wireless network access. At time point t₂, employee sponsor 220 determines a corresponding guest status level to be granted to the guest user. In this example, employee sponsor 232 determines that the guest user shall be granted the VIP guest status, and sends a message 234 to network device 210. Upon receiving the message from employee sponsor 220 indicating a particular guest status level, at time point t₃, network device 210 authenticates guest client device 200 with the particular guest status 236. At time point t₄, guest client device 200 is granted VIP access to the wireless network.

Because employee sponsor 220 is notified each time a guest user visits the facility and requests access to wireless networks, employee sponsor 220 can determine various guest statuses based on different situations. Therefore, the same guest user visiting the same employee sponsor may be granted different guest statuses during different visits. For example, if a salesperson visits a corporate office initially to meet with a contract manager to present a product to a management team, the salesperson may be granted a VIP guest status during the initial visit. Subsequently, the salesperson visits the corporate office to meet the contract manager for product training to a few testing engineers, the salesperson may be granted a non-VIP guest status for the subsequent visit.

Thus, as illustrated in FIG. 2, at time point t₆, which may be on a different day after the guest client device's authenticated VIP guest status expires, the same guest user visits the same facility and completes another registration 240 indicating the same employee sponsor 220. At time point t₆, network device 210 sends a notification message 242 to employee sponsor 220, indicating that the guest user has arrived and requests wireless network access. Notification message 242 can be, but is not limited to, a text message, a voicemail, a phone call, an email, a pop-up message from a mobile application, etc. This time, based on varied visiting situations, employee sponsor 220 may determine that guest client device 200 shall be granted non-VIP guest status, and sends a message 244 with the decision at time point t₇. Upon receiving the message from employee sponsor 220 indicating a non-VIP guest status level, at time point t₈, network device 210 authenticates guest client device 200 with the non-VIP guest status 246. At time point t₉, guest client device 200 is granted non-VIP access to the wireless network.

### Automatic Detection Based on Source of Guest Registration

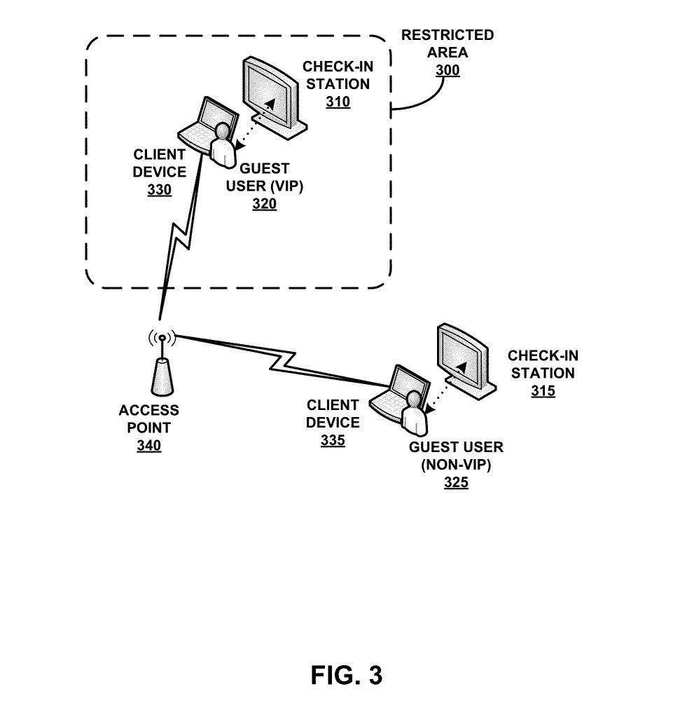

FIG. 3 shows an exemplary network diagram illustrating an exemplary automatic detection of VIP guests based on source of VIP registration according to embodiments of the present disclosure. Specifically, FIG. 3 illustrates a network deployed in a physical area that includes at least a restricted area 300. A network administrator can define a number of physical areas. Also, the network has a number of check-in stations that are used for wireless guest user registration. Some check-in stations, such as check-in station 310, are located within restricted area 300, whereas other check-in stations, such as check-in station 315, are located outside restricted area 300. In addition, the network administrator can also define a mapping between check-in stations located within a particular physical area to a particular guest status. Therefore, any guest user checking in at one of those check-in stations located within the particular physical area will be granted the particular guest status.

According to some embodiments of the present disclosure, if guest user 320 checks in at check-in station 310 located within a particular physical area, e.g., restricted area 300, guest user 320 will be granted a VIP guest status. Thus, client device 330 that guest user 320 uses will have a preferred level of wireless network access. Because guest user 320 is able to visit restricted area 300, the permission to visit a restricted physical area in an organization implies that guest user 320 is an important guest to the facility.

By contrast, if another guest user 325 checks in at check-in station 315 located outside the particular physical area, e.g., restricted area 300, guest user 325 will be granted a non-VIP guest status. Thus, client device 335 that guest user 325 uses will only have general wireless network access.

This is so even though guest client device 330 and guest client device 335 may be associated with the same access point in the wireless network. Because the respective guest users of the respective guest devices are granted different guest statuses, the guest devices will received differentiated wireless network access. Specifically, after a guest user successfully registers at a check-in station, the guest user may be given a passcode for logging in to the wireless network. A network policy engine may keep track of each generated passcode and its corresponding wireless network access level.

### Automatic Detection Based on Source of Email Domain of Guest Users

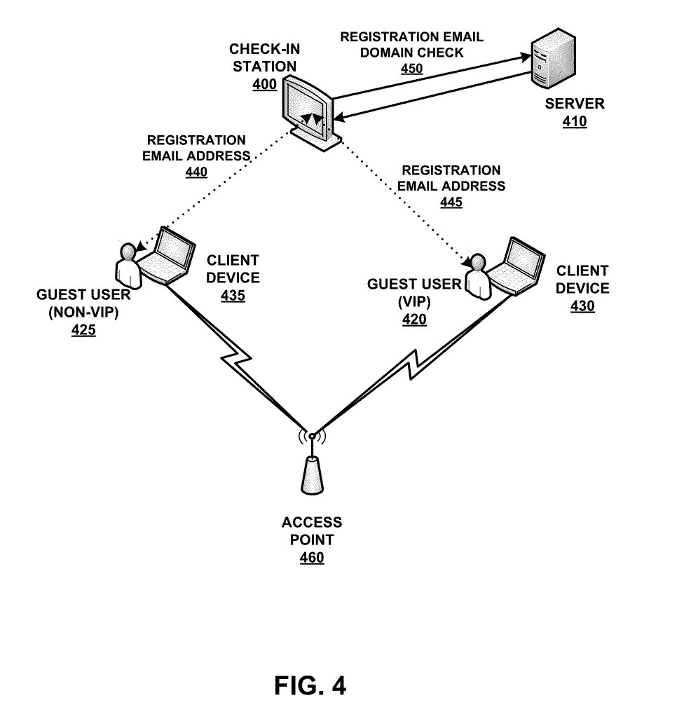

FIG. 4 shows an exemplary network diagram illustrating an exemplary automatic detection of VIP guests based on email domain of the guest user according to embodiments of the present disclosure. FIG. 4 includes at least a check-in station 400 where a guest of an organization can register as a visitor, a server 410 which stores at least a number of email domains that are identified as important affiliations, and one or more network devices, such as access point 460, that provide wireless network access.

When a guest user, such as guest user 420 and/or guest user 425, checks in at check-in station 400, the guest user is prompted for an email address. In this example, guest user 420 submitted registration email address 445 to check-in station 400, whereas guest user 425 submitted registration email address 440 to check-in station 400. Check-in station 400 can then extract the corresponding email domain from each submitted email address, and can request a registration email domain check 450 from server 410.

Server 410 performs a lookup in its stored list of email domains that are identified as important affiliations. Next, server 410 returns a message to check-in station 400 indicating whether it has found a match of the email domain in its stored list. If, for example, server 410 indicates that the email domain of guest user 420's registration email address 445 is matched to an important affiliation, check-in station 400 will grant guest user 420 a VIP guest status. Hence, client device 430 will receive preferred wireless network access from access point 460. As another example, if server 410 indicates that the email domain of guest user 425's registration email address 440 is not matched to an important affiliation, check-in station 400 will grant guest user 425 a non-VIP guest status. Thus, client device 435 will only receive general wireless network access from access point 460.

In some embodiments, the stored list of email domains may include, but are not limited to, existing or prospective customers, vendors, partners, or any other similar selected targets of an organization/corporation. If a guest user registers with his/her corporate email address during a first visit, the guest user can obtain preferred wireless network access because his/her email domain matches to an important business partner. However, the same guest user may register with his/her personal email address during a subsequent visit to a personal friend or relative at the organization/corporation, the guest user will only be given general wireless network access during the subsequent visit.

In some embodiments, a guest user from an existing customer may be given a different guest status than another guest user from a prospective customer. Moreover, if a guest user is identified as a prospective customer, the guest user may be shown a number of relevant advertisements upon his/her mobile client device logs on to the wireless network.

### Differentiated Monitoring or Treatments Based on Guest Statuses

The information technology (IT) department of an organization may define a number of user roles that are mapped to different access policies. The access policies can be one or more of: rule-based policies; access control lists (ACLs); etc. To implement differentiated monitoring or treatments based on guest statuses, an IT administrator will need to define a number of guest statuses, and maintain a mapping between such guest statuses and user roles. For example, the IT administrator can create a number of guest roles, e.g., GuestRole₁, GuestRole₂, GuestRole₃, etc. Moreover, the IT administrator will define what each of the guest roles can accomplish. For example, GuestRole₁ may be given full internal and external network access; GuestRole₂ may be given full external network access; GuestRole₃ may be given restricted external network access; etc. Note that, there may be other user roles that are defined by the IT administrator and do not correspond to any guest status, such as Employee_Role, Contractor_Role, Executive_Role, etc. Thus, the IT administrator will define a static mapping between the guest statuses and the guest roles. In some instances, a guest status may be mapped to one or more different user roles. For example, a VIP guest status may be mapped to either Employee_Role or GuestRole₁. In particular, a VIP guest status may be mapped to GuestRole₁ in a headquarter office, whereas the VIP guest status may be mapped to Employee_Role in a satellite office and GuestRole₃ in another satellite office.

User roles can determine many differentiated treatments of guest users, such as, which web resources a guest user can visit on the Internet or Intranet; what type of data that a guest user can access (e.g., whether the guest user is allowed to receive video and/or audio streams); which blacklist and/or whitelist of websites (e.g., websites with violence or pornography) apply to a guest user; which quality of service level is guaranteed for a guest user; which rate limits to apply to a guest user; which content filters to apply to a guest user; which subset of guest users to monitor; what service response time applies to a guest user; etc.

In some embodiments, when a salesperson that sells a software product for blocking violence contents from Internet visits an organization, the salesperson may be granted the VIP guest status that is mapped to a violence-allowing user role. Therefore, the salesperson will be able to access Internet websites with violence contents in order to demonstrate the software product. Note that, for all other user roles, the corresponding corporate and/or guest users will not be able to access any websites with violence contents.

In some embodiments, the wireless network may be exceeding its bandwidth while there are two guest users (one with a VIP guest status and the other with a non-VIP guest status) with two mobile client devices connected to the wireless network. Therefore, in order to continue providing network access to mobile client device of the guest user with the VIP guest status, the network system will disassociate with the mobile client device of the guest user with the non-VIP guest status.

In some embodiments, an IT administrator who monitors the wireless network performance may select to view only statuses of client devices associated with guest users having the VIP guest status. The IT administrator may desire enhanced monitoring of VIP guest users to ensure that their network access is good. Should any faults occur, they will be prioritized by the IT administrator. In some embodiments, the IT administrator may create a dedicated dashboard for guest users with VIP guest status.

There are multiple reasons why differentiated monitoring or treatments based on various guest statuses will be desirable. First, if a guest user who is granted a VIP guest status needs to be provided with a better wireless network experience than a guest user who is granted a non-VIP guest status. For example, a visitor to the CEO of the corporation should be provided with better wireless network experience than a maintenance worker of the facility.

Second, the set of services provided to VIP guests may be different from the set of services provided to non-VIP guests. For example, a non-VIP guest user may only have access to certain domains or websites on the Internet, whereas a VIP guest user may have full Internet access. Moreover, in some special circumstances, a VIP guest user may gain Intranet access, or access to some Intranet web resources. For example, a tax auditor may be given access to Intranet resources while visiting the corporate facility.

Note that, although only two levels of guest statuses (e.g., VIP guest status versus non-VIP guest status) are mentioned in the present disclosure, the same scheme can be applied to three or more guest statuses.

### Processes for Automatic Detection of VIP Guests on Wireless Networks

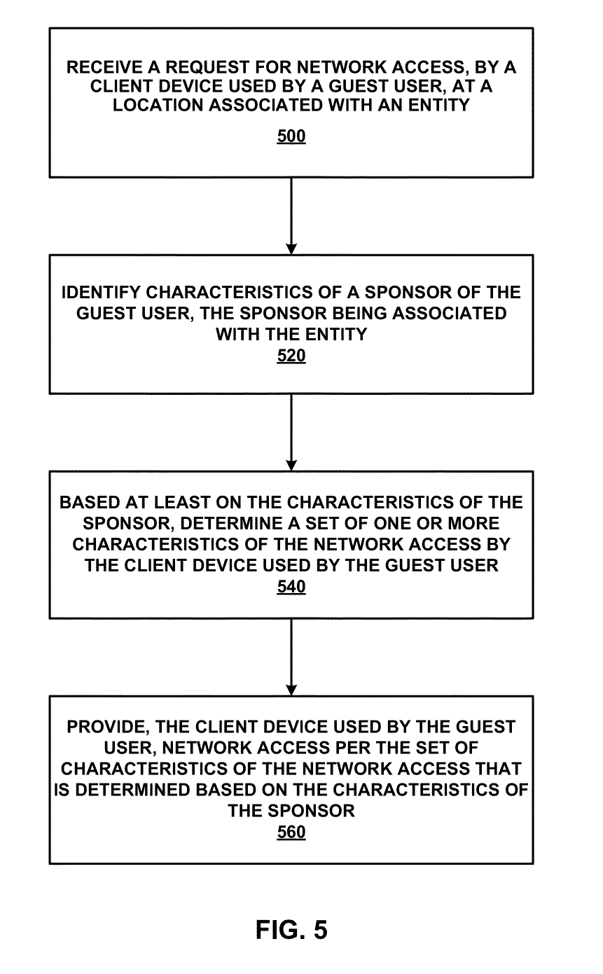

FIG. 5 illustrates an exemplary process for automatic detection of VIP guests on wireless networks according to embodiments of the present disclosure. Specifically, a network device can receive a request for network access, by a client device used by a guest user, at a location associated with an entity (operation 500). The network device can further identify characteristics of a sponsor of the guest user, whereas the sponsor is associated with the entity (operation 520). Based at least on the characteristics of the sponsor, the network device determines a set of one or more characteristics of the network access by the client device used by the guest user (operation 540). Finally, the network device provides, the client device used by the guest user, network access per the set of characteristics of the network access that is determined based on the characteristics of the sponsor (operation 560).

In some embodiments, the characteristics of the sponsor comprise one or more of: an employee status of the sponsor, an employee grade level of the sponsor, a priority associated with the sponsor, a role associated with the sponsor, or a position in an organization associated with the sponsor. In some embodiments, the characteristics of the sponsor comprise a department corresponding to the sponsor, e.g., office of CTO, etc. In some embodiments, the characteristics of the sponsor comprise user input received from the sponsor selecting the characteristics of the network access by the client device used by the guest user.

In some embodiments, the set of characteristics of the network access comprise one or more of: a speed, a bandwidth, a channel airtime, or priority associated with the network access. In some embodiments, the characteristics of the network access comprise a level of network access monitoring. In some embodiments, the characteristics of the network access include a level of service assigned to a device used by the guest user.

In some embodiments, the set of characteristics of the network access by the client device used by the guest user is determined further based on characteristics of a previous sponsor for the guest user. In some embodiments, the set of characteristics of the network access by the client device used by the guest user is determined further based on characteristics of the guest user. For example, the set of characteristics of the guest user may include, but is not limited to, the purpose of the visit, other attendants, the number of employee sponsors, other similar characteristics, etc.

In some embodiments, the characteristics of the network access by the client device define (a) a set of resources accessible by the client device and/or (b) a set of resources not accessible by the client device. In some embodiments, the characteristics of the network access by the client device define (a) content accessible by the client device and/or (b) content not accessible by the client device.

In some embodiments, the network device determines the set of characteristics of network access by assigning a role to the client device and determining the set of characteristics of network access based on the role.

In some embodiments, the set of characteristics of the network access include a priority level for the client device used by said guest user relative to priority levels assigned to devices used by other guest users. During network congestion or low bandwidth circumstances, a client device associated with a guest user with relatively low priority may be de-authenticated from the wireless network.

In some embodiments, the set of characteristics of the network access is further based on a device type of the client device. For example, a client device that is compatible with IEEE 802.11 ac standard may be given a high guest status in the wireless network.

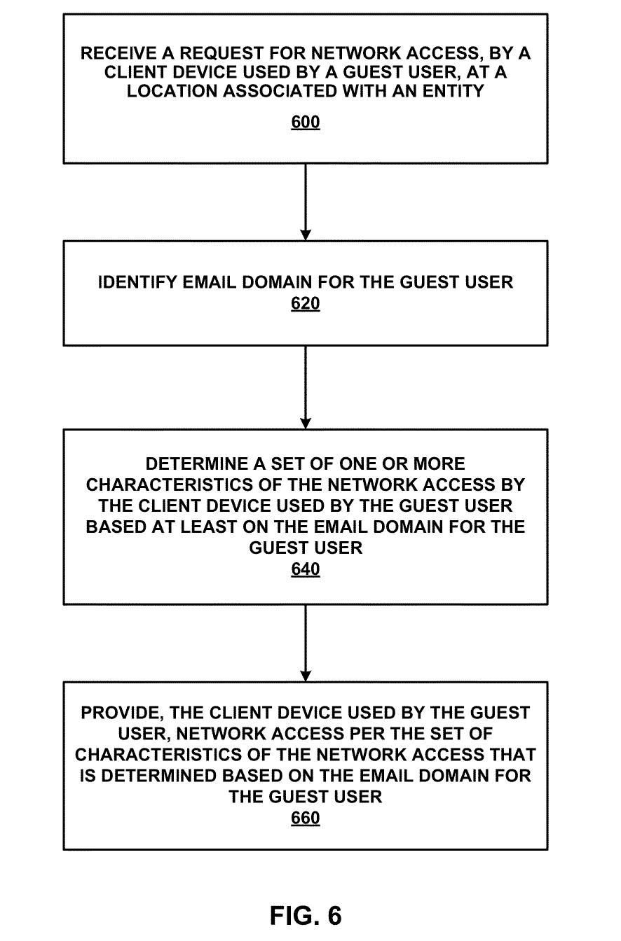

FIG. 6 illustrates an exemplary process for automatic detection of VIP guests on wireless networks according to embodiments of the present disclosure. Specifically, a network device can receive a request for network access, by a guest user, at a location associated with an entity (operation 600). The network device then identifies an email domain for the guest user (operation 620). Based at least on the email domain for the guest user, the network device determines a set of one or more characteristics of the network access by the guest user (operation 640). Finally, the network device provides the guest user network access per the characteristics of the network access that is determined based on the email domain for the guest user (operation 660). Note that, although only email domains are described in details in the present disclosure, the network device can use other contact information to identify a guest affiliation and determine a corresponding guest status based on the determined guest affiliation.

In some embodiments, the network device determines the set of one or more characteristics of the network access by the guest user based on one or more of: (a) whether the email domain is associated with a current customer for the entity, (b) the email domain is associated with a potential customer, (c) whether the email domain is associated with a current vendor for the entity, (d) the email domain is associated with a potential vendor, (e) whether the email domain is associated with a current partner for the entity, (f) the email domain is associated with a potential partner.

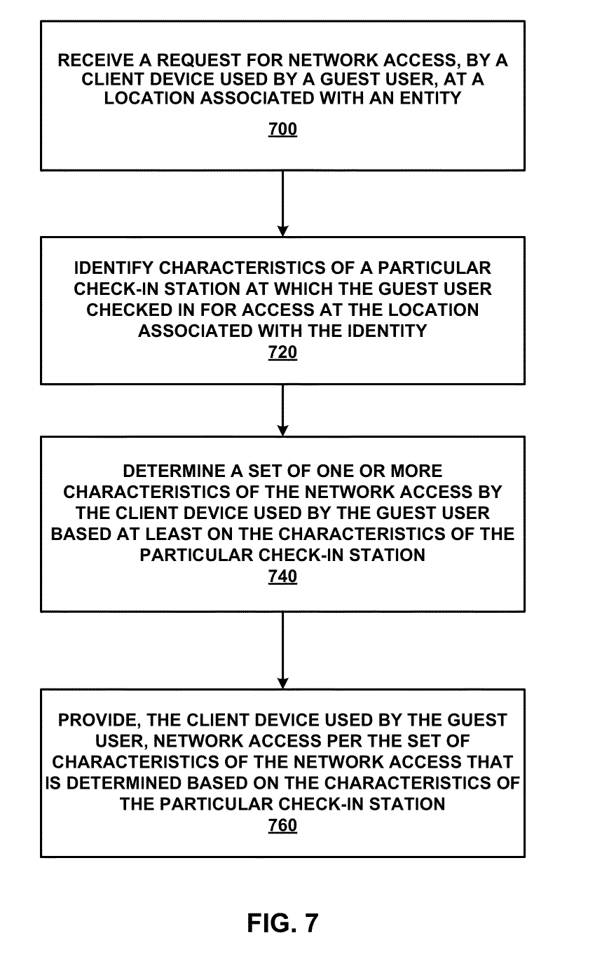

FIG. 7 illustrates an exemplary process for automatic detection of VIP guests on wireless networks according to embodiments of the present disclosure. Specifically, a network device can receive a request for network access, by a guest user, at a location associated with an entity (operation 700). The network device then identifies characteristics of a particular check-in station at which the guest user checked in for access at the location associated with the entity (operation 720). Based at least on the characteristics of the particular check-in station, the network device determines a set of one or more characteristics of the network access by the guest user (operation 740). Finally, the network device provides the guest user network access per the characteristics of the network access that is determined based on the set of characteristics of the particular check-in station (operation 760).

In some embodiments, the characteristics of the particular check-in station include a current location of the particular check-in station, e.g., when the particular check-in station is located inside an executive briefing center. In some embodiments, the characteristics of the particular check-in station comprise a configuration during a setup process for the check-in station.

In some embodiments, the characteristics of the particular check-in station include characteristics of an administrator associated with the particular check-in. For example, when a CEO's executive administrator logs in to unlock a particular check-in station prior to a corporate event, all guest users subsequently checking into the particular check-in station will be granted VIP guest status.

### System for Automatic Detection of VIP Guests on Wireless Networks

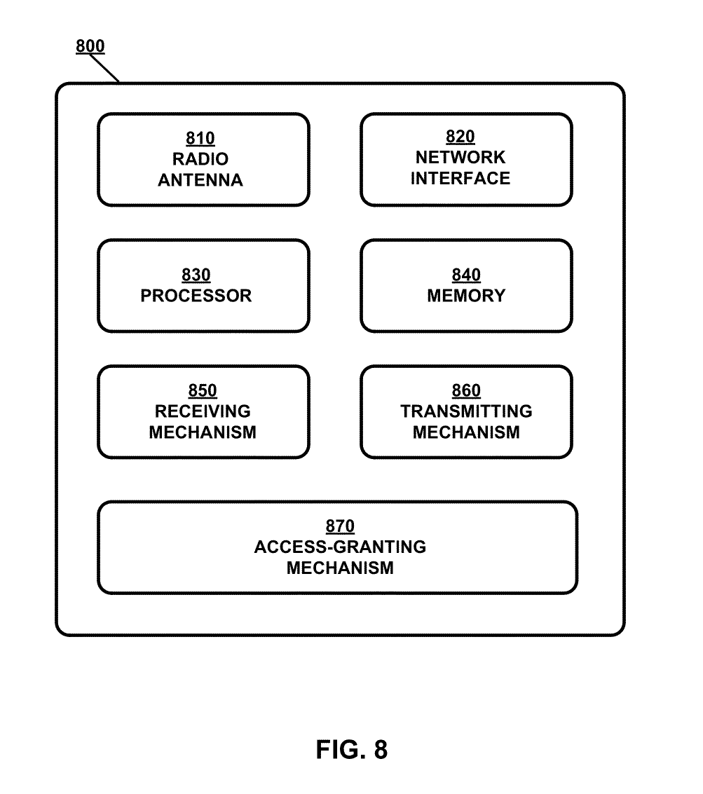

FIG. 8 is a block diagram illustrating a system for automatic detection of VIP guests on wireless networks. Network device 800 includes at least one or more radio antennas 810 capable of either transmitting or receiving radio signals or both, a network interface 820 capable of communicating to a wired or wireless network, a processor 830 capable of processing computing instructions, and a memory 840 capable of storing instructions and data. Moreover, network device 800 further includes a receiving mechanism 850, a transmitting mechanism 860, and an access-granting mechanism 870, all of which are in communication with processor 830 and/or memory 840 in network device 800. Network device 800 may be used as a client system, or a server system, or may serve both as a client and a server in a distributed or a cloud computing environment.

Radio antenna 810 may be any combination of known or conventional electrical components for receipt of signaling, including but not limited to, transistors, capacitors, resistors, multiplexers, wiring, registers, diodes or any other electrical components known or later become known.

Network interface 820 can be any communication interface, which includes but is not limited to, a modem, token ring interface, Ethernet interface, wireless IEEE 802.11 interface, cellular wireless interface, satellite transmission interface, or any other interface for coupling network devices.

Processor 830 can include one or more microprocessors and/or network processors. Memory 840 can include storage components, such as, Dynamic Random Access Memory (DRAM), Static Random Access Memory (SRAM), etc.

Receiving mechanism 850 generally receives one or more network messages via network interface 820 or radio antenna 810 from a wireless client. The received network messages may include, but are not limited to, requests and/or responses, beacon frames, management frames, control path frames, and so on. In particular, receiving mechanism 850 can receive a request for network access, by a guest user, at a location associated with an entity.

Transmitting mechanism 860 generally transmits messages, which include, but are not limited to, requests and/or responses, beacon frames, management frames, control path frames, and so on.

Access-granting mechanism 870 generally grants a particular guest status for a guest user. Specifically, access-granting mechanism 870 can identify characteristics of a sponsor of the guest user, the sponsor being associated with the entity; and/or email domain for the guest user; and/or characteristics of a particular check-in station at which the guest user checked in for access at the location associated with the entity. Access-granting mechanism 870 then determines a set of one or more characteristics of the network access by the client device used by the guest user. Further, access-granting mechanism 870 provides the client device used by the guest user network access per the determined set of characteristics of the network access.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network which links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A non-transitory computer readable medium comprising instructions which, when executed by one or more hardware processors, cause performance of operations comprising:
receiving a request for network access, by a client device used by a guest user, at a location associated with an entity;
identifying characteristics of a sponsor of the guest user, the sponsor being associated with the entity;
based at least on the characteristics of the sponsor, determining a set of one or more characteristics of the network access by the client device used by the guest user;
providing, the client device used by the guest user, network access per the set of characteristics of the network access that is determined based on the characteristics of the sponsor.

2. The medium of claim 1, wherein the characteristics of the sponsor comprise one or more of: an employee status of the sponsor, an employee grade level of the sponsor, a priority associated with the sponsor, a role associated with the sponsor, or a position in an organization associated with the sponsor.

3. The medium of claim 1, wherein the characteristics of the sponsor comprise a department corresponding to the sponsor.

4. The medium of claim 1, wherein the set of characteristics of the network access comprise one or more of: a speed, a bandwidth, a channel airtime, or priority associated with the network access.

5. The medium of claim 1, wherein the characteristics of the network access comprise a level of network access monitoring.

6. The medium of claim 1, wherein the characteristics of the network access comprise a level of service assigned to a device used by the guest user.

7. The medium of claim 1, wherein the characteristics of the sponsor comprise user input received from the sponsor selecting the characteristics of the network access by the client device used by the guest user.

8. The medium of claim 1, wherein the set of characteristics of the network access by the client device used by the guest user is determined further based on characteristics of a previous sponsor for the guest user.

9. The medium of claim 1, wherein the set of characteristics of the network access by the client device used by the guest user is determined further based on characteristics of the guest user.

10. The medium of claim 1, wherein the characteristics of the network access by the client device define (a) a set of resources accessible by the client device and/or (b) a set of resources not accessible by the client device.

11. The medium of claim 1, wherein the characteristics of the network access by the client device define (a) content accessible by the client device and/or (b) content not accessible by the client device.

12. The medium of claim 1, wherein determining the set of characteristics of network access by the client device used by the guest user comprises assigning a role to the client device and determining the set of characteristics of network access based on the role.

13. The medium of claim 1, wherein the set of characteristics of the network access comprise a priority level for the client device used by said guest user relative to priority levels assigned to devices used by other guest users.

14. The medium of claim 1, wherein the set of characteristics of the network access is further based on a device type of the client device.

15. A non-transitory computer readable medium comprising instructions which, when executed by one or more hardware processors, cause performance of operations comprising:
receiving a request for network access, by a guest user, at a location associated with an entity;
identifying email domain for the guest user;
based at least on the email domain for the guest user, determining a set of one or more characteristics of the network access by the guest user;
providing the guest user network access per the characteristics of the network access that is determined based on the email domain for the guest user.

16. The medium of claim 15, wherein the determining operation is based on one or more of: (a) whether the email domain is associated with a current customer for the entity, (b) the email domain is associated with a potential customer, (c) whether the email domain is associated with a current vendor for the entity, (d) the email domain is associated with a potential vendor, (e) whether the email domain is associated with a current partner for the entity, (f) the email domain is associated with a potential partner.

17. A non-transitory computer readable medium comprising instructions which, when executed by one or more hardware processors, cause performance of operations comprising:
receiving a request for network access, by a guest user, at a location associated with an entity;
identifying characteristics of a particular check-in station at which the guest user checked in for access at the location associated with the entity;
based at least on the characteristics of the particular check-in station, determining a set of one or more characteristics of the network access by the guest user;
providing the guest user network access per the characteristics of the network access that is determined based on the set of characteristics of the particular check-in station.

18. The medium of claim 17, wherein the characteristics of the particular check-in station comprise a current location of the particular check-in station.

19. The medium of claim 17, wherein the characteristics of the particular check-in station comprise characteristics of an administrator associated with the particular check-in.

20. The medium of claim 17, wherein the characteristics of the particular check-in station comprise a configuration during a setup process for the check-in station.
